(19) United States
(12) Patent Application Publication
(10) Pub. No.: US 2026/0263191 A1
(43) Pub. Date: Sep. 10, 2026

(54) DEVICE FOR TOOTH EXTRATION

(71) Applicant: HELMUT ZEPF MEDIZINTECHNIK GMBH, Seitingen-Oberflacht (DE)

(72) Inventor: Patrick ZEPF, Seitingen-Oberflacht (DE)

(21) Appl. No.: 19/164,931

(22) PCT Filed: Mar. 6, 2024
(86) PCT No.: PCT/EP2024/055763

§ 371 Date: Sep. 12, 2025

(30) Foreign Application Priority Data
Mar. 13, 2023 (DE) 10 2023 106 176.3

(51) Int. Cl. A61C 3/14

(52) U.S. Cl. CPC A61C 3/14

(57) ABSTRACT

A device for tooth extraction has a base element with a longitudinal axis, a distal end and a proximal end, and a pulling carriage moveable relative to the base element. The pulling carriage has a distal end and a proximal end. The device includes a pulling element having a first end and a second end. A first fastening device for fastening to the tooth or a fastening body fastened to the tooth is arranged at the first end, and a second fastening device for fastening to the pulling carriage is arranged at the second end. The pulling element is guided via a deflection part arranged on the base element. A tensioning device generating tensile force is arranged on the pulling carriage and can be actuated by means of an actuating element. The second fastening device has a partially spherical element with a diameter greater than that of the pulling element.

The invention relates to a device for tooth extraction according to the preamble of patent claim 1.

EP 1 578 296 B1 discloses a device for tooth extraction with a base element having a longitudinal axis, a distal end and a proximal end and a pulling carriage which is displaceable relative to the base element and has a distal end and a proximal end, and with a pulling element having a first end and a second end, wherein a first fastening device for fastening to the tooth or a fastening body fastened to the tooth is arranged at the first end and a second fastening device for fastening to the pulling carriage is arranged at the second end, wherein the pulling element is guided over a deflection part arranged on the base element, wherein a tensioning device for generating a tensile force is arranged on the pulling carriage, wherein the tensioning device can be actuated by means of an actuating element.

Such a device enables the extraction of a tooth, whereby in the following the term tooth always refers to a complete tooth as well as a part of a tooth, for example the tooth root, or dental prostheses such as dental crowns or dental implants. The device can be partially inserted into the mouth and supported there, whereby the force can be applied outside the oral cavity by means of the tensioning device and directed via the pulling element into the oral cavity and via the deflection part to the tooth to be extracted.

The second fastening device is designed as a cross pin, which are inserted behind a pair of curved hooks, which are arranged on the pulling carriage. Such a fastening is not easy to handle as it requires very sensitive positioning.

The object of the invention is therefore to further develop a device for tooth extraction in such a way that it is easier for a user to handle.

The object is achieved according to the invention by a device for tooth extraction comprising the features of patent claim 1.

Advantageous embodiments and further developments of the invention are specified in the dependent claims.

The device according to the invention for tooth extraction with a base element with a longitudinal axis, a distal end and a proximal end and a pulling carriage which is displaceable relative to the base element (20) and has a distal end and a proximal end, and with a pulling element with a first end and a second end, wherein a first fastening device for fastening to the tooth or a fastening body fastened to the tooth is arranged at the first end and a second fastening device for fastening to the pulling carriage is arranged at the second end, wherein the pulling element is guided via a deflection part arranged on the base element, wherein a tensioning device for generating a tensile force is arranged on the pulling carriage, wherein the tensioning device can be actuated by means of an actuating element, is characterized in that the second fastening device comprises a partially spherical element with a diameter which is larger than the diameter of the pulling element, and wherein the pulling carriage has at least one blind hole which has a lateral has a slot pointing towards the distal end of the pulling carriage. A second fastening device designed in this way enables a particularly easy-to-handle fixation of the pulling element to the pulling carriage by simply suspending the partially spherical element into the blind hole and guiding the pulling element through the lateral slot in the direction of the distal end. The partially spherical element reliably rests against the wall of the blind hole without the need for sensitive positioning.

Preferably, a longitudinal axis of the tension element is arranged coaxially to an axis of symmetry of the partially spherical element, so that the curvature of the partially spherical element extends around the pulling element. This allows good fastening even with significantly different orientations. Such a second fastening device can in particular compensate for large tolerances when fastening the fastening device to the pulling carriage.

Preferably, the pulling carriage has at least two, preferably four, blind holes arranged next to one another in the longitudinal direction, each of the blind holes having a lateral slot pointing towards the distal end of the pulling carriage. A number of blind holes allow easy adaptation to the anatomical conditions of a patient.

A preferred embodiment of the invention provides that the second fastening device comprises a pin-like element with a diameter which is larger than the diameter of the pulling element and with a longitudinal axis which is arranged parallel to the longitudinal axis of the pulling element, wherein the a partially spherical element is arranged on the pin-like element, and the diameter of the partially spherical element is larger than the diameter of the pin-like element. Such a pin-like element can improve the positioning of the second fastening device in the blind hole by the pin-like element coming to lie in the lateral slot.

A particularly simple and reliable connection between the second fastening device and the pulling element can be made possible if the pin-like element is preferably designed as a press bushing into which the pulling element is pressed.

According to an advantageous development of the invention, the pin-like element has a length which is greater than the length of the partially spherical element, wherein in particular the pin-like element projects in the longitudinal direction on both sides beyond the partially spherical element. Such a configuration can further improve the positioning of the second fastening device.

Preferably, the blind hole closest to the proximal end of the pulling carriage has a lateral slot pointing towards the proximal end of the pulling carriage. Such a configuration can further improve the positioning of the second fastening device by having the pin-like element lie in two diametrically opposite slots of a blind hole.

A particularly preferred embodiment of the invention provides that the base element has a measurement standard and a marking for interaction with the measurement standard is arranged on the pulling carriage. A measurement standard can visualize to the user the distance the pulling carriage has already moved.

According to an advantageous development of the invention, the base element is designed to be open to an upper side in a first section and has a groove running in the longitudinal direction, wherein the pulling carriage is arranged to be longitudinally displaceable in the groove. Such a groove allows good guidance of the pulling carriage and can be easily cleaned.

A preferred embodiment of the invention provides that the base element, starting from the proximal end, has a second section in which the base element is tubular with an axial through-opening, wherein the through-opening merges into the groove of the first section, and the pulling carriage is arranged so as to be longitudinally displaceable in the groove and the through-opening. Such a design can further improve the guidance of the carriage and its cleanability.

Preferably, the deflection part is arranged at a distal end of the groove, wherein the groove has an opening below the deflection part. This allows the deflection part to be arranged in a protected manner within the groove. The deflection part can, for example, be designed as a deflection roller, which can be fastened by means of a pin that crosses the groove.

A preferred development of the invention provides that at the distal end of the base element on a bottom side of the base element, in particular distal to the opening, a first support element is arranged, preferably detachably fastened, which has a positioning contour for aligning the pulling element. Such a positioning contour can ensure the alignment of the pulling element in the direction of the tooth to be extracted and thus facilitate the attachment of the first end of the pulling element to the tooth to be extracted or to a fastening body attached to the tooth.

Preferably, the positioning contour is concave, whereby a lateral deflection of the pulling element can be prevented. Advantageously, the positioning contour is V-shaped.

According to an advantageous embodiment of the invention, at least one second support element is arranged on an underside of the base element, in particular proximal to the opening, preferably in a detachable manner. Such a support element can enable flexible placement of the device in the oral cavity.

The pulling element is advantageously designed as a wire, a rope or a string, whereby a certain flexibility in the positioning of the pulling element relative to the tooth to be extracted can be achieved.

Advantageously, the tensioning device comprises a threaded rod arranged at the proximal end of the pulling carriage, which is led out of the base element through a support sleeve arranged at the proximal end of the base element, wherein the actuating element is screwed onto the threaded rod with an internal thread and is arranged so as to be axially supported on the support sleeve in order to generate the tensile force, and wherein a spring element for generating a restoring force is arranged between the pulling carriage and the support sleeve. Such a tensioning device enables a structurally simple design.

According to an advantageous embodiment, the support sleeve is screwed onto the proximal end of the base element by means of a threaded connection. Such a design enables the device to be disassembled and subsequently cleaned in a particularly simple manner.

Particularly preferably, the actuating element has an inner contour which can be placed in a form-fitting manner on an outer contour of the support sleeve. The inner contour can, for example, be arranged on the side of the actuating element facing away from the tensioning device. To disassemble the device, after loosening the connection between the actuating element and the tensioning device, the actuating element can be turned over and placed with the inner contour on the outer contour of the support sleeve in order to unscrew the support sleeve from the base element. A separate tool for disassembling the device is therefore not required.

The invention is explained in detail with reference to the following figures. It shows

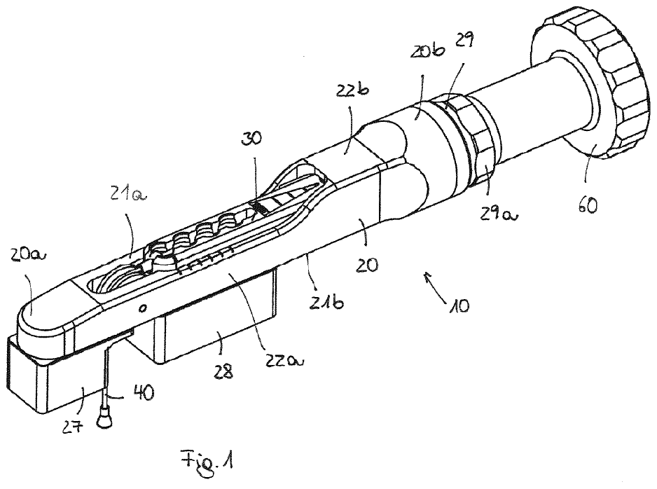

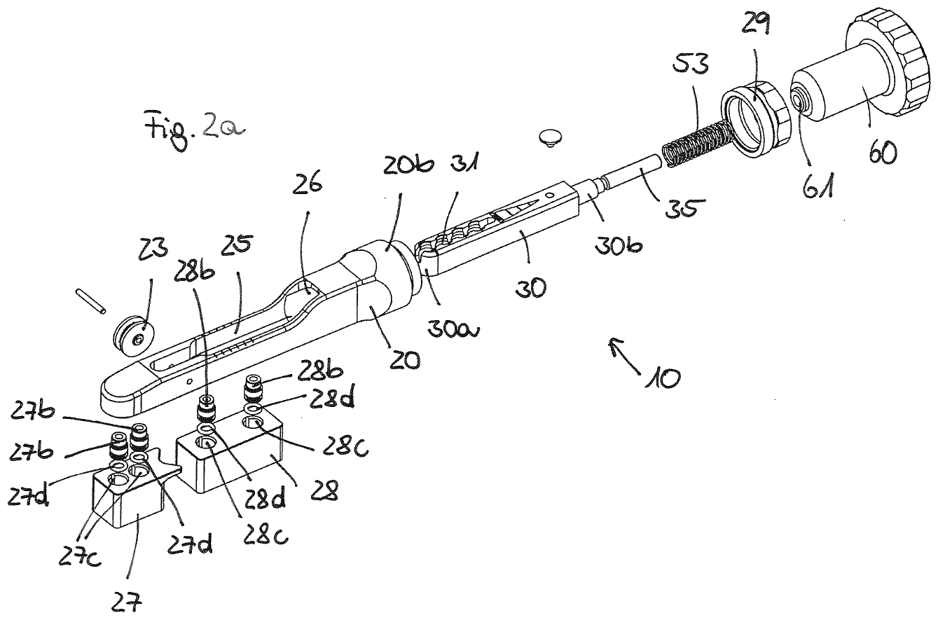

FIG. 1 is a perspective view of an embodiment of a device for tooth extraction according to the invention,

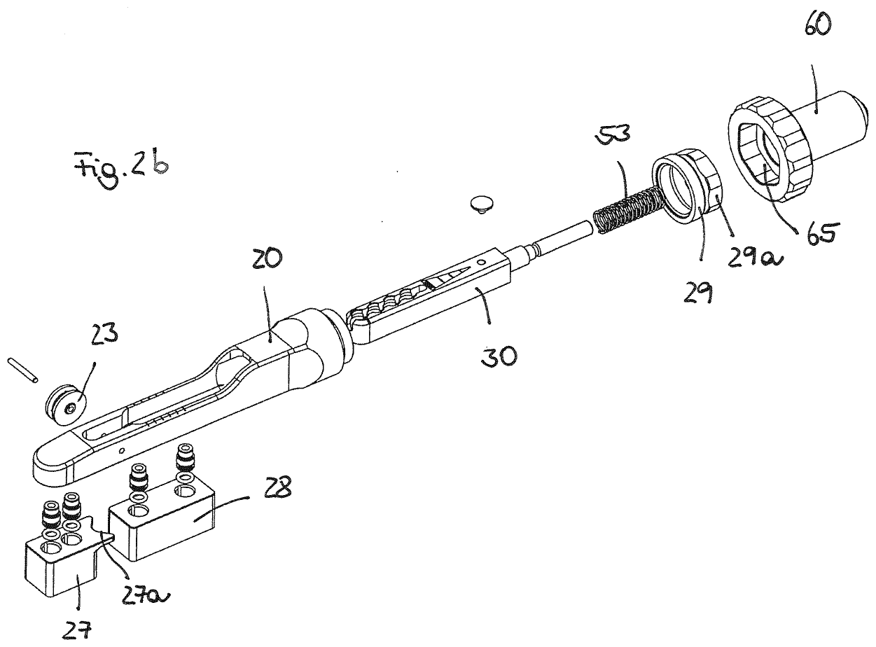

FIG. 2a is an exploded view of the device according to FIG. 1,

FIG. 2b shows the exploded view according to FIG. 2a with rotated actuating element,

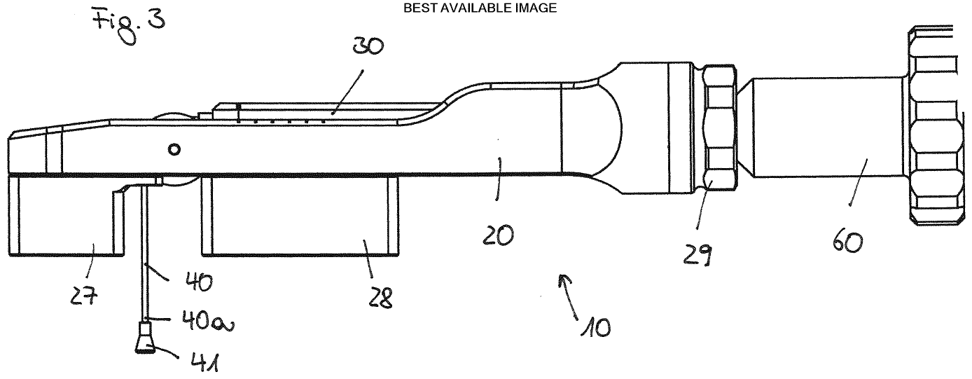

FIG. 3 is a side view of the device according to FIG. 1,

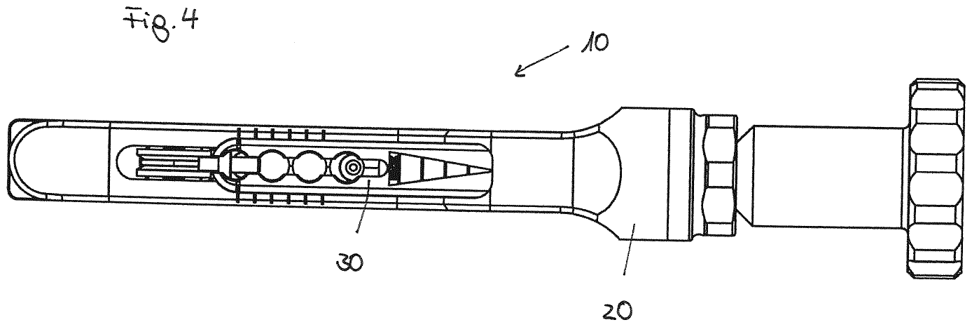

FIG. 4 is a plan view of the device according to FIG. 1,

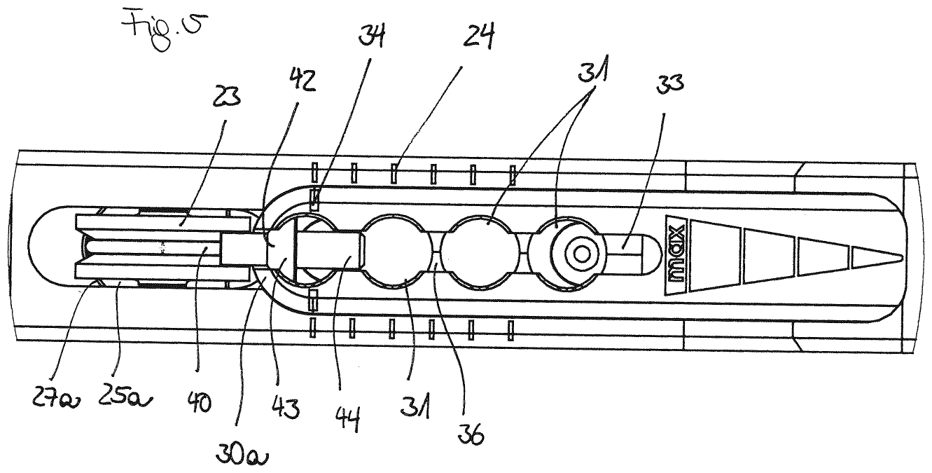

FIG. 5 is an enlarged detail of FIG. 4 and

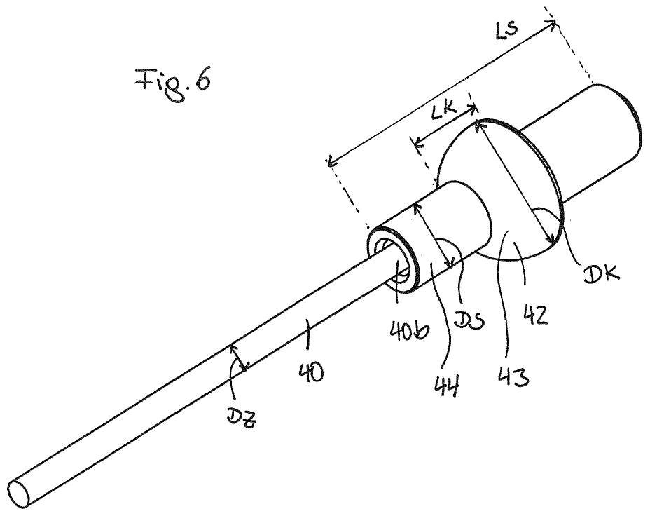

FIG. 6 is a perspective view of the second end of the pulling element of the device according to FIG. 1.

FIGS. 1 to 6 show different views of an embodiment of a device 10 for tooth extraction and components thereof.

The device 10 for tooth extraction comprises a base element 20 with a longitudinal axis L, a distal end 20a and a proximal end 20b and a pulling carriage displaceable relative to the base element 20 and having a distal end 30a and a proximal end 30b.

Furthermore, the device 10 comprises a pulling element 40 with a first end 40a and a second end 40b, wherein a first fastening device 41 for fastening to the tooth or a fastening body fastened to the tooth is arranged at the first end 40a and a second fastening device 42 for fastening to the pulling carriage 30 is arranged at the second end 40b. The pulling element 40 is guided over a deflection part 23 arranged on the base element 20. The deflection part 23 causes the pulling element 40 to be deflected by approximately 90°. While a section of the pulling element 40 adjacent to the second fastening device 42 is arranged substantially parallel to the longitudinal axis L of the device 10, a section of the pulling element 40 adjacent to the second fastening device 41 is arranged substantially transversely to the longitudinal axis L of the device 10, in particular in the extraction direction of the tooth to be extracted.

A tensioning device 50 for generating a tensile force is arranged on the pulling carriage 30, wherein the tensioning device 50 can be actuated by means of an actuating element 60. The actuating element 60 is in particular rotatable about the longitudinal axis L and can be designed, for example, as a knurled nut. The tensioning device 50 can comprise a threaded rod 35 arranged at the proximal end 30b of the pulling carriage 30, which is led out of the base element 20 through a support sleeve 29 arranged at the proximal end 20b of the base element 20. The support sleeve 29 is in particular screwed onto the proximal end 20b of the base element 20 by means of a threaded connection. The actuating element 60 can be screwed onto the threaded rod 35 with an internal thread 61 and can be arranged to be axially supported on the support sleeve 29 in order to generate the tensile force. The tensioning device 50 may further comprise a spring element 53 which is arranged between the pulling carriage 30 and the support sleeve 29 for generating a restoring force. If the actuating element 60 is rotated about the longitudinal axis L, the threaded rod 35 is screwed into or unscrewed from the actuating element 60, depending on the direction of rotation. The spring element 53 causes the actuating element 60 to rest against the support sleeve 29. If the threaded rod 35 is screwed into the actuating element 60, the pulling carriage 30 is moved relative to the base element 20 to the proximal end 20b of the base element 20 and a pulling force is exerted on the pulling element 40, so that a tensile force can be exerted on the tooth to be extracted via the pulling element 40.

As can be seen in particular in FIG. 4 and FIG. 5, the base element 20 can have a measurement standard 24, for example in the form of a scale with several equidistantly arranged markings. On the carriage 30 a marking 34 for interaction with the measurement standard 24 can be arranged. If the pulling carriage 30 is moved relative to the base element 20, the marking 34 moves relative to the measurement standard 24 so that the distance travelled can be recorded.

The base element 20 can have a first axial section 22a and a second axial section 22b, which in particular borders the proximal end 20b of the base element 20. In the first section 22a, the base element 20 is open to an upper side 21a and has a groove 25 running in the longitudinal direction, wherein the pulling carriage 30 is arranged to be longitudinally displaceable in the groove 25. In particular, the pulling carriage 30 is accessible in the first section 22a from the upper side 21a, but is otherwise arranged embedded in the base element 20. In the second section 22b, the base element 20 is tubular with an axial through-opening 26, wherein the through-opening 26 merges into the groove 25 of the first section 22a, and the pulling carriage 30 is arranged so as to be longitudinally displaceable in the groove 25 and the through-opening 26. The base element 20 can be made in one piece from a solid material rod.

The deflection part 23 is arranged in particular at a distal end of the groove 25. For example, the deflection part 23 can be designed as a deflection roller, which can be arranged by means of a cross pin on the side walls of the groove 25 and can be mounted so as to be rotatable about the cross pin. The groove 25 can have an opening 25a below the deflection part 23, through which the pulling element 40 can be guided towards the tooth to be extracted.

The pulling element 40 can be designed as a wire, a rope or a string and has a diameter DZ.

The first fastening device 41 of the pulling element 40 can, for example, be designed as a hook or thickening which can engage in a corresponding eyelet or recess of a fastening body screwed into the tooth to be extracted.

The second fastening device 42 comprises a partially spherical element 43 with a diameter DK which is larger than the diameter DK of the pulling element 40 (see in particular FIG. 6). For example, the partially spherical element 43 can be designed as a hemisphere. In particular, a longitudinal axis of the pulling element 40 is arranged coaxially to an axis of symmetry of the partially spherical element 43. The curvature of the partially spherical element 43 points in particular in the direction of the first end 40a of the pulling element 40. The second fastening device 42 can, in addition to the partially spherical element 43, have a pin-like element 44 with a diameter DS that is larger than the diameter DZ of the pulling element, but smaller than the diameter DK of the partially spherical element 43. The longitudinal axis of the pin-like element 44 is arranged parallel to the longitudinal axis of the pulling element 40. The pin-like element 44 can be designed as a press bushing into which the pulling element 40, in particular the second end 40b of the pulling element 40, is pressed. The partially spherical element 43 can be arranged on the pin-like element 44. The pin-like element 44 can have a length LS which is greater than the length LK of the partially spherical element 43, wherein in particular the pin-like element 44 projects in the longitudinal directionon both sides beyond the partially spherical element 43. In other words, the spherical element 43 is penetrated by the pin-like element 44.

The pulling carriage 30 has at least one blind hole 31 which has a lateral slot 32 pointing towards the distal end 30a of the pulling carriage 30 (see in particular FIGS. 4 and 5). Preferably, the pulling carriage 30 has at least two, in the illustrated embodiment four, blind holes 31 lying next to one another in the longitudinal direction, each of the blind holes 31 having a lateral slot 32 pointing towards the distal end 30a of the pulling carriage 30. The lateral slots 32 extend in particular to the respective distally adjacent blind hole 31, so that a longitudinal groove 36 is formed which extends over all blind holes 31 and extends to the distal end 30a of the pulling carriage 30. The second fastening device 42 of the pulling element 40 can be inserted into one of the blind holes 31. Due to the round cross-section of the blind hole 31 and the partially spherical element 43 a good positioning can be achireved. The pin-like element 44 enables good alignment by lying in the longitudinal groove 36. The blind hole 31 located closest to the proximal end 30b of the pulling carriage 30 can have a lateral slot 33 pointing towards the proximal end 30b of the pulling carriage 30, in which the pin-like element 44 projecting beyond the partially spherical element 43 can come to rest.

If the second fastening device 42 is inserted into the blind hole 31, the pulling element 40 can be guided through the longitudinal groove 36 to the deflection part 23 and from there, after deflection through the opening 25a, to the underside 21b of the base element 20 and further to the tooth to be extracted (see especially FIGS. 1 and 3).

At the distal end 20a of the base element 20, on an underside 21b of the base element 20, in particular distal of the opening 25a, a first support element 27 can be arranged, preferably detachably fastened, which has a positioning contour 27a for aligning the pulling element 40. With the support element 27, the device 10 can be positioned in the oral cavity. The positioning contour 27a forms an alignment aid for the pulling element 40 and guides the pulling element 40, which is guided over the deflection part 23 and which may initially be deflected by significantly less than 90° due to its rigidity, into the desired alignment. The positioning contour 27a can, for example, be concave. In particular, the positioning contour 27a can be V-shaped (see in particular FIGS. 2a and 2b).

Furthermore, at least one second support element 28 can be arranged, preferably detachably fastened, on the underside 21b of the base element 20, in particular proximal to the opening 25a.

The detachable fastening of the first support element 27 and/or the second support element 28 can be realized, for example, in that at least one, preferably two, pins 27b, 28b, per support element 27, 28 are arranged on the underside 21b of the base element 20 to prevent rotation, which pins engage in recesses 27c, 28c arranged on the respective support element 27, 28 in a substantially frictionally engaged manner. To increase the frictional engagement, circumferential rubber rings 27d, 28d can be arranged on the pins 27b, 28b (see in particular FIGS. 2a and 2b).

To clean the device 10, the actuating element 60 can first be unscrewed from the threaded rod 35. The support sleeve 29 can then be unscrewed from the base element 20. For this purpose, the actuating element 60 can have, in particular on its end face facing away from the internal thread 61, an inner contour 65 which can be placed in a form-fitting manner on an outer contour 29a of the support sleeve 29 (cf. in particular FIG. 2b). The pulling carriage 30 can then be pulled out of the base element 20 (see in particular FIGS. 2a and 2b).

### Reference Symbol List

10 device
20 base element
20a distal end
20b proximal end
21a upper side
21b underside
22a first section
22b second section
23 deflection part
24 measurement standard
25 groove
25a opening
26 through-opening
27 first support element
27a positioning contour
27b pin
27c recess
27d rubber ring
28 first support element
28b pin
28c recess
28d rubber ring
29 support sleeve
29a outer contour
30 pulling carriage
30a distal end
30b proximal end
31 blind hole
32 lateral slot
33 lateral slot
34 marking
35 threaded rod
36 longitudinal groove
40 pulling element
40a first end
40b second end
41 first fastening device
42 second fastening device
43 partially spherical element
44 pin-like element
50 tensioning device
53 spring element
60 actuating element
61 internal thread
65 inner contour
L Longitudinal axis
DK diameter
DS diameter
DZ diameter
LK length
LS length

1. Device (10) for tooth extraction, comprising a base element (20) with a longitudinal axis (L), a distal end (20a) and a proximal end (20b), and a pulling carriage (30) which can be moved relative to the base element (20) and has a distal end (30a) and a proximal end (30b), and comprising a pulling element (40) having a first end (40a) and a second end (40b), wherein a first fastening device (41) for fastening to the tooth or a fastening body fastened to the tooth is arranged at the first end (40a), and a second fastening device (42) for fastening to the pulling carriage (30) is arranged at the second end (40b), wherein the pulling element (40) is guided via a deflection part (23) arranged on the base element (20), wherein a tensioning device (50) for generating a tensile force is arranged on the pulling carriage (30), wherein the tensioning device (50) can be actuated by means of an actuating element (60), characterized in that the second fastening device (42) comprises a partially spherical element (43) with a diameter (DK) which is greater than the diameter (DZ) of the pulling element (40), and wherein the pulling carriage (30) has at least one blind hole (31) which has a lateral slot (32) pointing towards the distal end (30a) of the pulling carriage (30).

2. Device according to claim 1, characterized in that a longitudinal axis of the pulling element (40) is arranged coaxially to an axis of symmetry of the partially spherical element (43).

3. Device according to claim 1, characterized in that the pulling carriage (30) has at least two, preferably four, blind holes (31) lying next to one another in the longitudinal direction, each of the blind holes (31) having a lateral slot (32) pointing towards the distal end (30a) of the pulling carriage (30).

4. Device according to claim 1, characterized in that the second fastening device (42) comprises a pin-like element (44) with a diameter (DS) which is greater than the diameter (DZ) of the pulling element (40) and with a longitudinal axis which is arranged parallel to the longitudinal axis of the pulling element (40), wherein the partially spherical element (43) is arranged on the pin-like element and the diameter (DK) of the partially spherical element (43) is greater than the diameter (DS) of the pin-like element (44).

5. Device according to claim 1, characterized in that the pin-like element (44) is designed as a press bushing into which the pulling element (40) is pressed.

6. Device according to claim 1, characterized in that the pin-like element (44) has a length (LS) which is greater than the length (LK) of the partially spherical element (43), wherein in particular the pin-like element (44) projects in the longitudinal direction on both sides beyond the partially spherical element (43).

7. Device according to claim 1, characterized in that the blind hole (31) closest to the proximal end (30b) of the pulling slide (30) has a lateral slot (33) pointing towards the proximal end (30b) of the pulling slide (30).

8. Device according to claim 1, characterized in that the base element (20) has a measurement standard (24) and a marking (34) for interacting with the measurement standard is arranged on the pulling carriage (30).

9. Device according to one claim 1, characterized in that the base element (20) is open in a first section (22a) to an upper side (21a) and has a groove (25) running in the longitudinal direction, wherein the pulling carriage (30) is arranged to be longitudinally displaceable in the groove (25).

10. Device according to claim 1, characterized in that the base element (20), starting from the proximal end (20b), has a second section (22b) in which the base element (20) is tubular with an axial through-opening (26), wherein the through-opening (26) merges into the groove (25) of the first section (22a), and the pulling carriage (30) is arranged to be longitudinally displaceable in the groove (25) and the through-opening (26).

11. Device according to claim 1, characterized in that the deflection part (23) is arranged at a distal end of the groove (25) and the groove (25) has an opening (25a) below the deflection part (23).

12. Device according to claim 1, characterized in that at the distal end (20a) of the base element (20) on an underside (21b) of the base element (20), in particular distal of the opening (25a), a first support element (27) is arranged, preferably detachably fastened, which has a positioning contour (27a) for aligning the pulling element (40).

13. Device according to claim 12, characterized in that the positioning contour (27a) is concave.

14. Device according to claim 12, characterized in that the positioning contour (27a) is V-shaped.

15. Device according to claim 1, characterized in that at least one second support element (28) is arranged, preferably detachably fastened, on an underside (21b) of the base element (20), in particular proximal to the opening (25a).

16. Device according to claim 1, characterized in that the pulling element (40) is designed as a wire, a rope or a string.

17. Device according to claim 1, characterized in that the tensioning device (50) comprises a threaded rod (35) arranged at the proximal end (30b) of the pulling carriage (30), which is led out of the base element (20) through a support sleeve (29) arranged at the proximal end (20b) of the base element (20), wherein the actuating element (60) is screwed onto the threaded rod (35) with an internal thread (61) and is arranged so as to be axially supported on the support sleeve (29) in order to generate the tensile force, and wherein between the pulling carriage (30) and the support sleeve (29) a spring element (53) is arranged to generate a restoring force.

18. Device according to claim 1, characterized in that the support sleeve (29) is screwed onto the proximal end (20b) of the base element (20) by means of a threaded connection.

19. Device according to one claim 1, characterized in that the actuating element (60) has an inner contour (65) which can be placed in a form-fitting manner on an outer contour (29a) of the support sleeve (29).
